(19) United States
(12) Patent Application Publication
(10) Pub. No.: US 2020/0028980 A1
(43) Pub. Date: Jan. 23, 2020

(54) IMAGE FORMING APPARATUS AND CORRECTION METHOD BY THE SAME

(71) Applicant: TOSHIBA TEC KABUSHIKI KAISHA, Tokyo (JP)

(72) Inventor: Motoki II, Izunokuni Shizuoka (JP)

(21) Appl. No.: 16/039,561

(22) Filed: Jul. 19, 2018

(51) Int. Cl. H04N 1/00; G06F 3/041

(52) U.S. Cl. CPC H04N 1/00411; G06F 3/04883; H04N 1/00514; G06F 3/0418

(57) ABSTRACT

An image forming apparatus comprises a housing, an input unit, a motor, and a controller. The input unit comprises an input section, a sensor configured to detect an object within an area facing the input section and output a signal in response to detection of an object within the area facing the input section, and a rotary coupling having an axis of rotation and connecting the input unit to the housing, such that the input unit is positionable by the swinging thereof along a path centered on the axis of rotation to position the input section to face two different directions. The motor is connected to the coupling, and the controller is configured to receive the signal from the sensor, and selectively control the motor to change the facing direction of the input section based on the value of the signal output by the sensor.

### FIELD

Embodiments described herein relate generally to an image forming apparatus and a correction method by the same.

### BACKGROUND

An image forming apparatus provided with a touch panel capable of being moved so that an angle of its display surface can be changed, is known. In such a touch panel, depending on the angle of the display surface, the part of the touch panel that a finger of an operator touches is changed. Therefore, if the angle of the touch panel is changed, the touch coordinates may be deviated. In order to prevent the above deviation of the touch coordinates, coordinate correction is required every time the angle of the touch panel is changed, which is troublesome.

### DESCRIPTION OF THE DRAWINGS

FIG. 1 is a perspective external view of an image forming apparatus according to an embodiment;

FIG. 2 is a block diagram illustrating a circuit configuration of the main portions of the image forming apparatus in FIG. 1;

FIG. 3 is a side view depicting the outline and operation of the image forming apparatus in FIG. 1;

FIG. 4 is a flowchart depicting an example of a control process by a processor in FIG. 2 according to an embodiment;

FIG. 5 is a flowchart depicting an example of the control process by the processor in FIG. 2 according to the embodiment;

FIG. 6 is a graph illustrating an example of output values from a human sensor;

FIG. 7 is a diagram illustrating a state of touching a touch panel with a finger;

FIG. 8 is a diagram illustrating the state of touching the touch panel with the finger;

FIG. 9 is a diagram illustrating an example of a relationship between an angle θ and a correction value y2; and

FIG. 10 is a side view for depicting a modification of the image forming apparatus.

### DETAILED DESCRIPTION

In accordance with an embodiment, an image forming apparatus comprises a housing, an input unit, a motor, and a controller. The input unit comprises an input section, a sensor configured to detect an object within an area facing the input section and output a signal in response to detection of an object within the area facing the input section, and a rotary coupling having an axis of rotation and connecting the input unit to the housing, such that the input unit is positionable by the swinging thereof along a path centered on the axis of rotation to position the input section to face two different directions. The motor is connected to the coupling, and the controller is configured to receive the signal from the sensor, and selectively control the motor to change the facing direction of the input section based on the value of the signal output by the sensor.

Hereinafter, an image forming apparatus according to the embodiment will be described with reference to the accompanying drawings. For ease of explanation, the drawings used for describing the embodiment show the respective parts with the scales thereof appropriately changed. Additionally, the drawings used for describing the embodiments may omit a component in some cases.

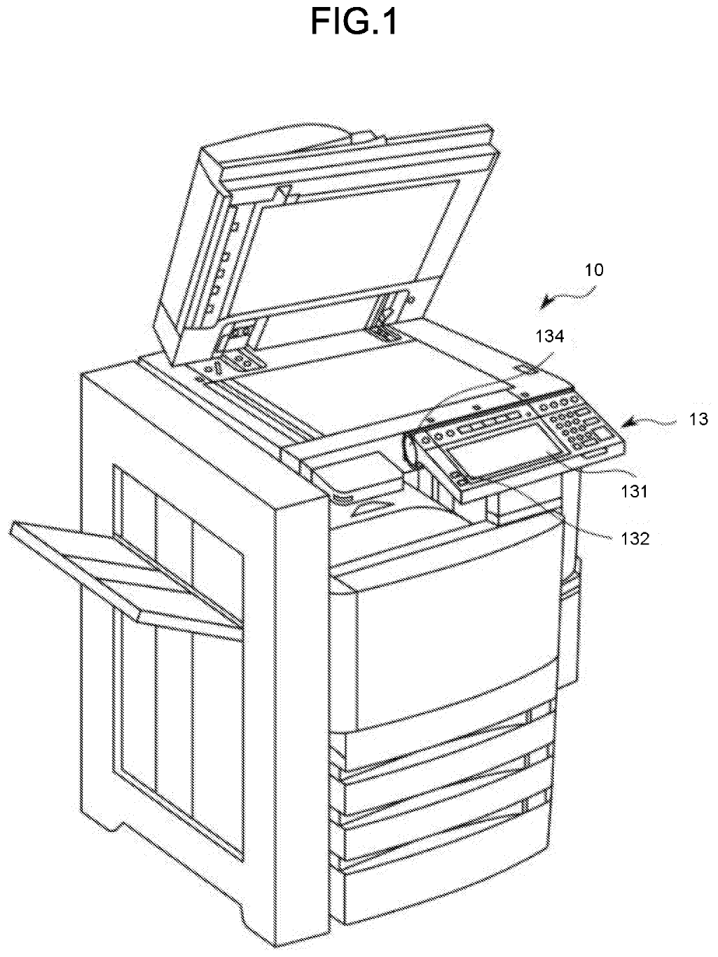

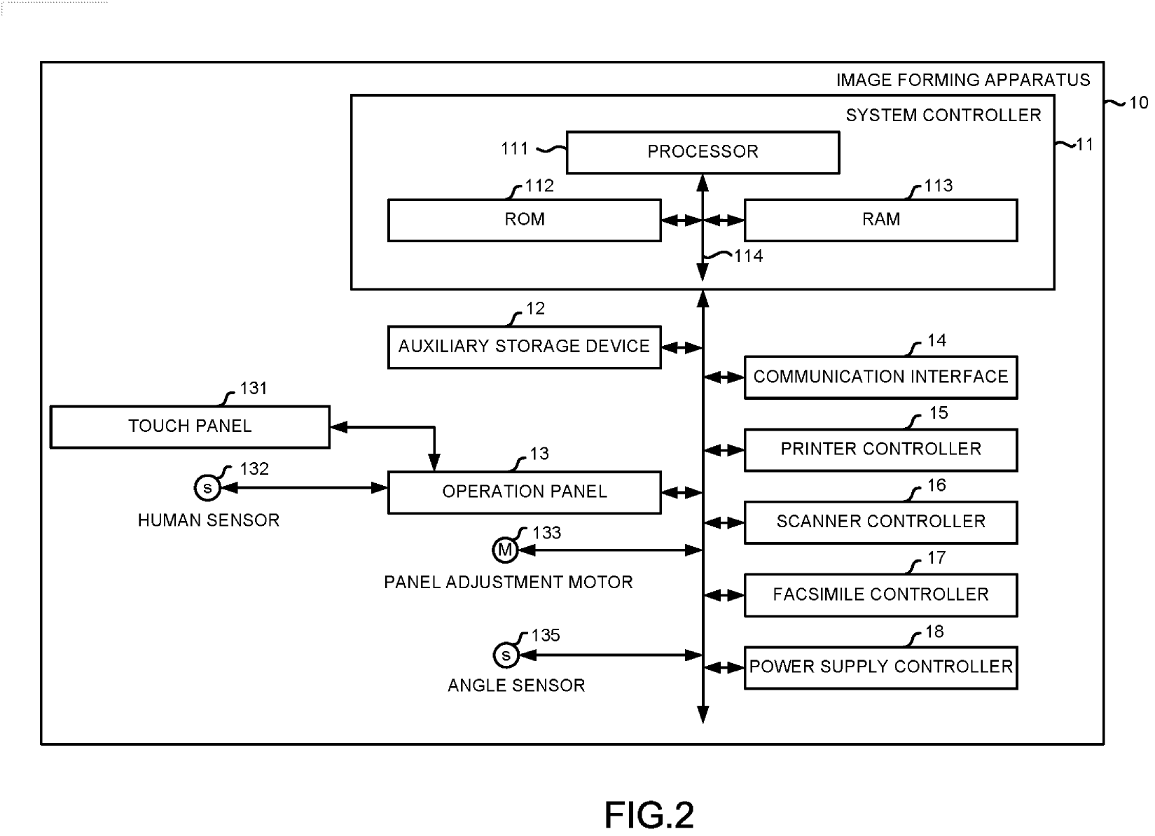

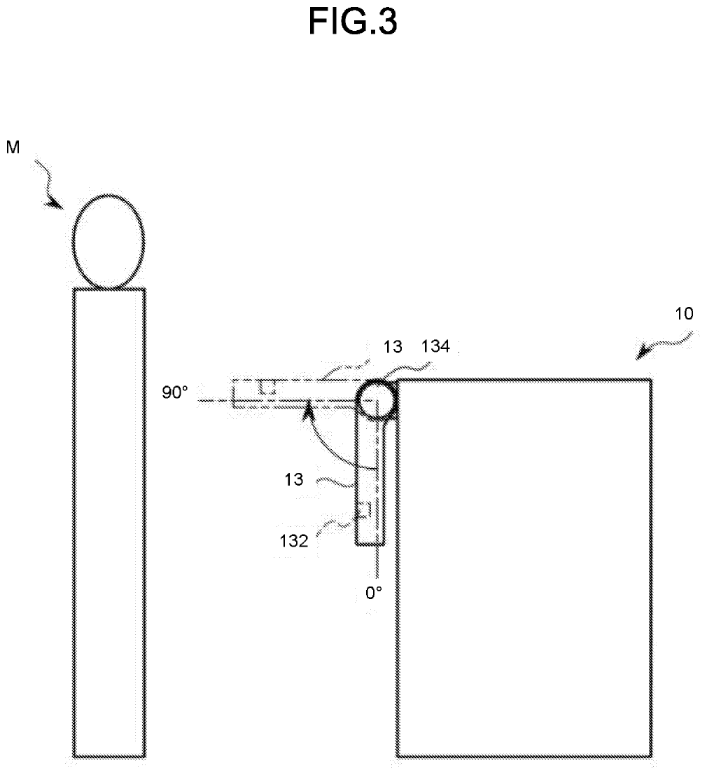

An image forming apparatus 10 according to the embodiment is described with reference to FIG. 1 to FIG. 3. FIG. 1 is an external perspective view of the image forming apparatus 10. FIG. 2 is a block diagram illustrating a circuit configuration of the main portions of the image forming apparatus 10. FIG. 3 is a side view depicting the outline and operation of the image forming apparatus 10.

The image forming apparatus 10 includes, in its housing, for example, a printing function, a scanning function, a copying function, a facsimile function, and the like. The printing function is a function of forming an image using a recording material such as a toner or ink on an image forming medium or the like. The image forming medium is, for example, a sheet-like paper. The scanning function is a function of reading an image from a document on which the image is formed. The copying function is a function of printing the image read from the document on an image forming medium. The image forming apparatus is, for example, a MFP (multifunction peripheral), a copy machine, a printer, a facsimile, or the like. The image forming apparatus 10 includes, for example, a system controller 11, an auxiliary storage device 12, an operation panel 13, a communication interface 14, a printer controller 15, a scanner controller 16, a facsimile controller 17 and a power supply controller 18.

The system controller 11 controls each section of the image forming apparatus 10. The system controller 11 includes a processor 111, a ROM (read-only memory) 112, and a RAM (random-access memory) 113. The system controller 11 is an example of a controller.

The processor 111 acts as a central part of a computer that performs a calculation process and a control process necessary for the operation of the image forming apparatus 10. The processor 111 controls each section to realize various functions of the image forming apparatus 10 by executing programs such as system software, application software or firmware stored in the ROM 112 or the auxiliary storage device 12. The processor 111 is, for example, a CPU (central processing unit), a MPU (micro processing unit), a SoC (system on a chip), a DSP (digital signal processor) or a GPU (graphics processing unit). Alternatively, the processor 111 may be a combination of those. The processor 111 is an example of a controller. Also, a computer with the processor 111 as the center is an example of the controller.

The ROM 112 acts as a main storage device of a computer with the processor 111 as the center. The ROM 112 is a non-volatile memory exclusively used for reading out data therefrom. The ROM 112 stores the above programs. The ROM 112 stores data used for various processes performed by the processor 111, various setting values, or the like.

The RAM 113 acts as a main storage device of the computer with the processor 111 as the center. The RAM 113 is a memory used for reading and writing data. The RAM 113 is used as a so-called work area for storing data temporarily used for the various processes performed by the processor 111.

The auxiliary storage device 12 acts as an auxiliary storage device of the computer with the processor 111 as the center. The auxiliary storage device 12 is, for example, an EEPROM (electric erasable programmable read-only memory), a HDD (hard disk drive), a SSD (solid state drive), or the like. The auxiliary storage device 12 may store the above programs. The auxiliary storage device 12 stores data used for various processes performed by the processor 111, data generated by processes in the processor 111, various setting values, and the like. The image forming apparatus 10 may have an interface capable of inserting a storage medium such as a memory card or a USB (Universal Serial Bus) memory in place of the auxiliary storage device 12 or in addition to the auxiliary storage device 12. The auxiliary storage device 12 stores information relating to each user in association with a user ID (identifier). The user ID is an identification symbol uniquely assigned to each user. The auxiliary storage device 12 is an example of a storage section.

The programs stored in the ROM 112 or the auxiliary storage device 12 includes a control program described with respect to a control process described later. As an example, the image forming apparatus 10 is provided to an administrator of the image forming apparatus 10 with the control program stored in the ROM 112 or the auxiliary storage device 12. However, the image forming apparatus 10 may be provided to the administrator in a state in which the control program described with respect to the control process described below is not stored in the ROM 112 or the auxiliary storage device 12. The image forming apparatus 10 may be provided to the administrator with another control program stored in the ROM 112 or the auxiliary storage device 12. The control program described with respect to the control process described later may be separately provided to the administrator and written into the ROM 112 or the auxiliary storage device 12 under the operation of the administrator or a service person. The delivery of the control program at this time can be realized by recording the control program on a removable storage medium such as a magnetic disk, a magneto-optical disk, an optical disk, a semiconductor memory or the like, or by downloading the control program via a network.

The programs stored in the ROM 112 or the auxiliary storage device 12 include, for example, a threshold value U1 and a threshold value U2. The threshold value U1 and the threshold value U2 are determined, for example, by a designer of the image forming apparatus 10. Alternatively, each of the threshold value U1 and the threshold value U2 may be set by the administrator of the image forming apparatus 10.

The operation panel 13 includes a button for an operator M of the image forming apparatus 10 to operate, a touch panel 131, a human sensor 132, a panel adjustment motor (hereinafter, referred to as “motor”) 133, a rotating section 134, and an angle sensor 135. The button of the operation panel 13 functions as an input device for receiving an operation by the operator M.

The touch panel 131 includes a display such as a liquid crystal display or an organic EL display, and a touch pad laminated on the display. The display of the touch panel 131 functions as a display device for displaying a screen for notifying the operator M of various information. Furthermore, the touch pad of the touch panel 131 functions as an input device for receiving a touch operation by the operator M.

Under the control of the processor 111, the touch panel 131 displays various information about the image forming apparatus 10. The various information relates to various functions such as printing, scanning, copying, facsimile or the like. For example, the various information includes information indicating a state of the image forming apparatus 10, setting values, or the like.

For example, the human sensor 132 is provided in such a manner that a sensor direction faces a normal direction of a display surface side of the display surface of the touch panel 131 and thus the area in the detectable range and detection coverage in the direction the sensor is facing can be considered as a sensor facing area. For example, the human sensor 132 measures a physical quantity that changes depending on a distance to an object such as the operator M in the sensor sensing direction and outputs it. As an example, a value output by the human sensor 132 is larger as the distance between the human sensor 132 and the object becomes shorter. The human sensor 132 performs measurement using, for example, electromagnetic waves such as infrared rays, visible light or radio waves, ultrasonic waves, or a combination thereof.

The arrangement of the human sensor 132 shown in FIG. 1 and FIG. 3 is an example. The human sensor 132 may be provided at a position different from the position shown in FIG. 1 and FIG. 3.

The motor 133 swings the operation panel 13 in a path along the rotation direction of the rotating section 134 centered on the axis of rotation of the rotating section. The motor 133 is an example of a first motor.

The rotating section 134 is, for example, a hinge. The operation panel 13 moves integrally with the touch panel 131 and the human sensor 132. As shown in FIG. 3, the operation panel 13 is moveable around a rotation center (first axis) of the rotating section 134 in the rotation direction of the rotating section 134, for example, in a range of elevation and rotation angles including 0 degree to 90 degrees. The angle of the touch panel 131 when the display surface of the touch panel 131 is perpendicular to the ground and the display surface faces a side where the operator M stands, as shown by a solid line in FIG. 3, is set to 0 degree. In other words, a direction in which the display surface of the touch panel 131 is in parallel with the front surface of the image forming apparatus 10 is 0 degree. An angle of the touch panel 131 when the display surface of the touch panel 131 is parallel to the ground and the display surface faces the opposite side of the ground, as shown by a broken line in FIG. 3, is set to 90 degrees. In other words, a direction in which the display surface of the touch panel 131 faces the ceiling or sky is 90 degrees. The rotatable range of the rotating section 134 may be wider or narrower than 0 degree to 90 degrees.

The angle sensor 135 measures the angle of the operation panel 13 with respect to the front surface of the image forming apparatus 10 or other point of reference. The angle sensor 135 is, for example, an encoder sensor, a gyro sensor, a potentiometer or a resolver. The angle sensor 135 is an example of a first measurement section measuring the elevation or depression angle of the touch panel 131.

The motor 133 may be a motor such as a stepping motor of which degrees or partial degrees of rotation, and thus the rotation angle, can be precisely controlled. In this case, for example, the processor 111 measures the angle of the operation panel 13 from the number of motor control pulses applied to the motor 133. In this case, the motor 133 and the processor 111 cooperate to function as an example of the first measurement section.

The communication interface 14 is an interface through which the image forming apparatus 10 performs communication. The communication interface 14 conforms to a standard such as USB (Universal Serial Bus) or Ethernet (registered trademark), for example.

The printer controller 15 controls a printer of the image forming apparatus 10. The printer is, for example, a laser printer, an inkjet printer or other types of printers.

The scanner controller 16 controls a scanner of the image forming apparatus 10. The scanner is an optical reduction system including an image capturing element such as a CCD (charge-coupled device) image sensor, for example. Alternatively, the scanner may be a contact sensor (CIS (contact image sensor)) system including an image capturing element such as a CMOS (complementary metal-oxide-semiconductor) image sensor. Alternatively, the scanner may be other known systems.

The facsimile controller 17 controls a facsimile function of the image forming apparatus 10.

The power supply controller 18 controls a power supply of the image forming apparatus 10. The power supply supplies power to each section of the image forming apparatus 10.

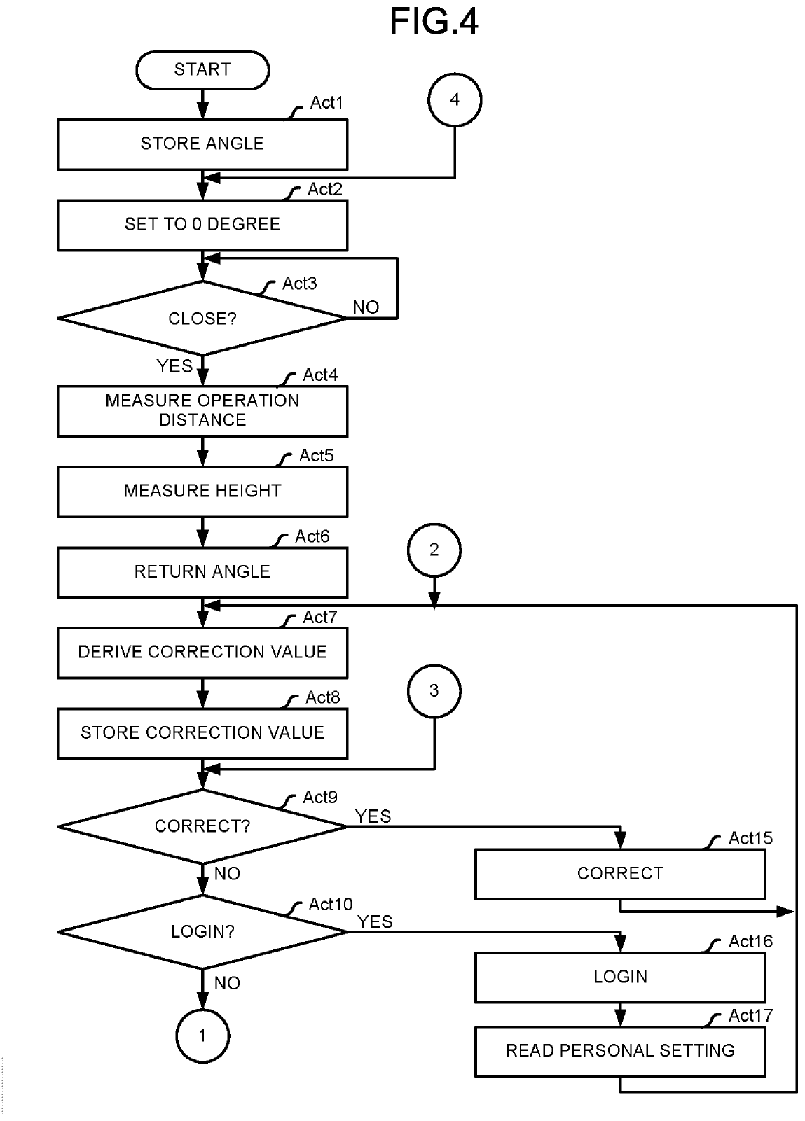

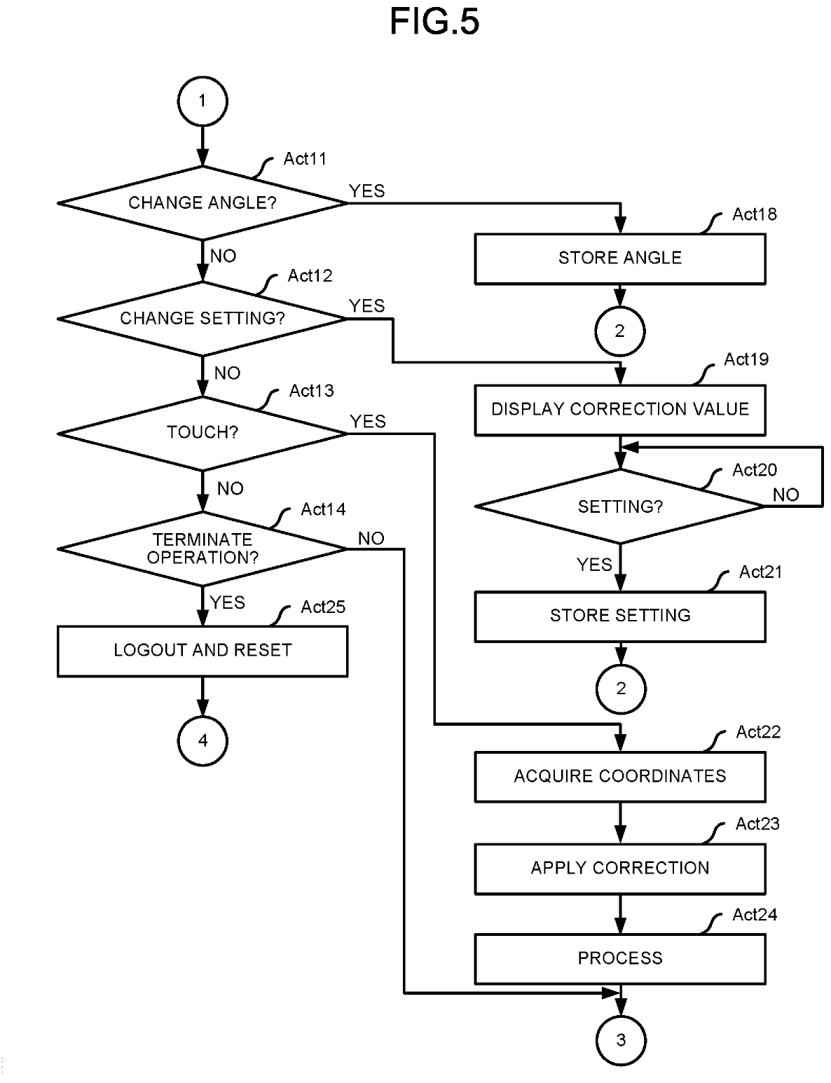

Hereinafter, the operation of the image forming apparatus 10 according to the embodiment is described with reference to FIG. 4 and FIG. 5. The contents of processes in the following operation description are merely an example, and various processes capable of obtaining the same result can be suitably used. FIG. 4 and FIG. 5 are flowcharts depicting control processes by the processor 111 of the image forming apparatus 10. The processor 111 executes the control program stored in the ROM 112 or the auxiliary storage device 12 to perform the control process. The processor 111 starts the control process shown in FIG. 4 in response to activation of the image forming apparatus 10. If the processor 111 proceeds to the process in Act (N+1) after the process in Act N (N is a natural number), the description thereof may be omitted. Names of variables in the following explanation are examples.

The processor 111 starts the processes shown in FIG. 4 and FIG. 5, for example, in response to that the power supply to the image forming apparatus 10 is turned on.

In Act 1 in FIG. 4, the processor 111 acquires the angle of the operation panel 13 from the angle sensor 135. Then, the processor 111 substitutes the acquired angle for a variable VA.

In Act 2, the processor 111 controls the motor 133 in such a manner that the angle of the operation panel 13 becomes 0 degrees. Through this control, the angle of the operation panel 13 becomes 0 degrees as shown by the solid line in FIG. 3.

In Act 3, the processor 111 stands by until the operator M gets close to the operation panel 13. For example, the processor 111 stands by until an output value of the human sensor 132 is equal to or greater than the threshold value U1. The processor 111 determines that the operator M gets close to the operation panel 13 if a time change rate of the output value becomes equal to or less than a certain value while the output value of the human sensor 132 is equal to or greater than the threshold value U1. As the output value becomes equal to or greater than the threshold value U1, it can be known that the operator M gets close within a certain range from the operation panel 13. Then, it can be known that the operator M stops at a spot if the time change rate became equal to or less than the certain value. If the operator M gets close to the operation panel 13, the processor 111 determines Yes in Act 3 and proceeds to the process in Act 4.

In Act 4, the processor 111 measures a distance (hereinafter, referred to as an “operation distance”) between the operator M and the human sensor 132. The output value of the human sensor 132 varies depending on the distance from the human sensor 132 to the operator M, and becomes larger as the distance is shorter. Therefore, the processor 111 derives the operation distance from the output value of the human sensor 132. The processor 111 causes the RAM 113 to store the derived operation distance.

From the above, the processor 111 cooperates with the human sensor 132 to function as a third measurement section that measures the distance to the operator.

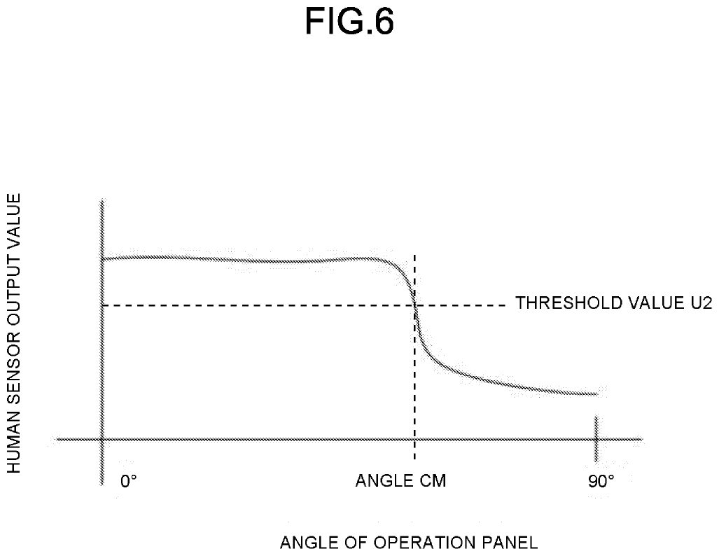

In Act 5, the processor 111 measures the body height of the operator M as follows. The processor 111 causes the RAM 113 to store the measured body height. The processor 111 controls the motor 133 to change the angle of the operation panel from 0 degree to 90 degrees. At this time, the processor 111 causes the RAM 113 to store the output value of the human sensor 132 while the angle of the operation panel is changed from 0 degree to 90 degrees. The output value of the human sensor 132 while the angle of the operation panel is changed from 0 degree to 90 degrees is as shown in FIG. 6. FIG. 6 is a graph illustrating an example of the output value of the human sensor 132. An angle CM is an angle of the operation panel 13 when an angle change rate of the output value of the human sensor 132 is maximum. In other words, the angle CM is the angle of the operation panel 13 when an absolute value of angle derivative of the output value of the human sensor 132 is maximum. Alternatively, the angle CM may be the angle of the operation panel 13 when the output value of the human sensor 132 changes from a value larger than the threshold value U2 to the threshold value U2 or less. The processor 111 derives the angle CM based on the output value of the human sensor 132. If the angle of the operation panel 13 is the angle CM, the sensor direction of the human sensor 132 faces a direction of the head of the operator M as seen from the human sensor 132.

Through the above, the processor 111 cooperates with the human sensor 132 to function as a second measurement section for measuring the body height of the operator M. That is, the processor 111 derives the body height of the operator M based on the operation distance sensed by the human sensor 132, the angle CM and the location of the human sensor 132.

In Act 6, the processor 111 controls the motor 133 to set the angle of the operation panel 13 to an angle indicated by the variable VA.

In Act 7, the processor 111 derives a correction value y2 and a correction value Y from the body height of the operator M, the angle of the operation panel 13, a reference angle, a reference body height, a reference distance, and the correction value y1. The derivation of the correction value y2 and the correction value Y is described later.

In Act 8, the processor 111 causes the RAM 113 to store the correction value y2 and the correction value Y derived in Act 7, for example.

In Act 9, the processor 111 determines whether or not an operation for starting the setting of a correction value x1 and the correction value y1 is performed. If the operation for starting the setting of the correction value x1 and the correction value y1 is not performed, the processor 111 determines No in Act 9 and proceeds to the process in Act 10.

In Act 10, the processor 111 determines whether or not an operation for starting login is performed. If the operation for starting the login is not performed, the processor 111 determines No in Act 10 and proceeds to the process in Act 11 in FIG. 5.

In Act 11, the processor 111 determines whether or not an operation for changing the angle of the operation panel 13 is performed before the operator M touches the touch panel. If the operation for changing the angle of the operation panel 13 is not performed, the processor 111 determines No in Act 11 and proceeds to the process in Act 12.

In Act 12, the processor 111 determines whether or not an operation for changing a personal setting is performed. If the operation for confirming and changing the personal setting is not performed, the processor 111 determines No in Act 12 and proceeds to the process in Act 13. The personal setting is described later.

In Act 13, the processor 111 determines whether or not a touch operation is performed on the touch panel 131. If the touch operation is not performed on the touch panel 131, the processor 111 determines No in Act 13 and proceeds to the process in Act 14.

In Act 14, the processor 111 determines whether or not the operation by the operator M is finished. If the operation by the operator M is not finished, the processor 111 determines No in Act 14 and returns to the process in Act 9 in FIG. 4. Thus, the processor 111 repeats the processes in Act 9 to Act 14 until the operation of starting the setting of the correction value x1 and the correction value y1, the operation of starting the login, the operation for changing the angle of the operation panel 13 or the operation for confirming and changing the personal setting is performed, the touch operation on the touch panel 131 is performed, or the operation by the operator M is finished.

If the operation for starting the settings of the correction value x1 and the correction value y1 is performed when the processor 111 is in the standby state in Act 9 to Act 14, the processor 111 determines Yes in Act 9 and proceeds to the process in Act 15.

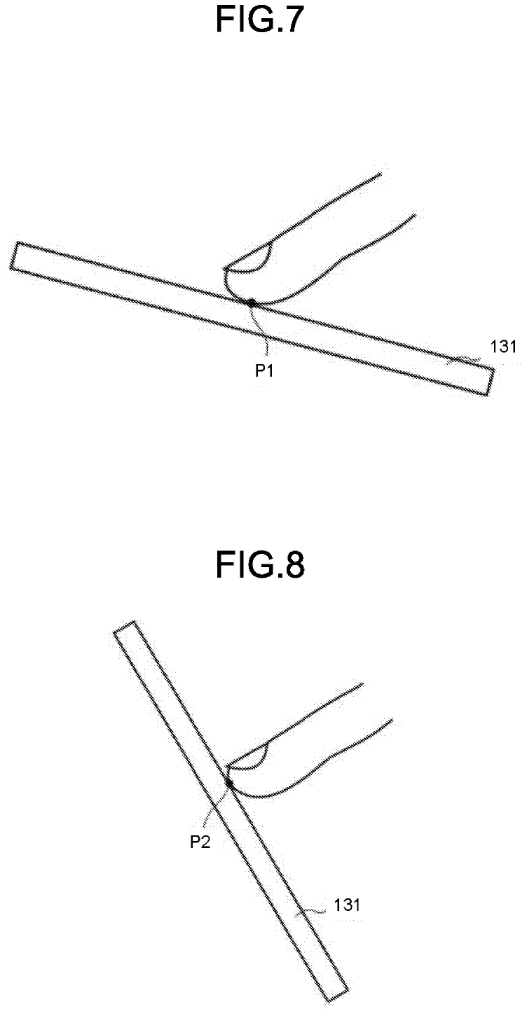

In Act 15, the processor 111 executes a process for deriving the correction value x1 and the correction value y1. The correction value x1 and the correction value y1 can be used to correct deviation of touch coordinates in the reference angle, the reference body height, and the reference distance. Specifically, the correction value x1 and the correction value y1 can be used to correct the deviation of the touch coordinates by regarding the touch on coordinates (x, y) as the touch on coordinates (x+x1, y+y1) if the angle of the operation panel 13 is the reference angle, the body height of the operator M is the reference body height and the operation distance is the reference distance. However, when the angle of the operation panel 13 is not the reference angle, the body height of the operator M is not the reference body height, or the operation distance is not the reference distance, if the coordinates are corrected using the correction value x1 and the correction value y1, the corrected touch coordinates may be deviated from actual touch coordinates. As shown in FIG. 7, if the angle of the touch panel 131 (the angle of the operation panel 13) is nearly horizontal, a portion P1 close to a finger cushion touches the touch panel 131. Therefore, if the angle of the touch panel 131 is larger than the reference angle, the touch position is deviated downwards from the position where the operator M wants to touch. As shown in FIG. 8, when the angle of the touch panel 131 is nearly vertical, a portion P2 near the tip of the finger touches the touch panel 131. Therefore, if the angle of the touch panel 131 is smaller than the reference angle, the actual touch position is deviated upwards from the position the operator M wants to touch. As described above, the deviation occurs in the touch coordinates as the portions of the finger which touches the touch panel 131 are different depending on the angle of the touch panel 131. Even if the body height of the operator M is different from the reference body height, a deviation occurs in the touch coordinates as in the case in which the angle of the touch panel 131 is different from the reference angle. If the body height of the operator M is taller than the reference body height, a portion close to the finger cushion touches the touch panel 131. Therefore, the actual touch position is deviated downwards from the position that the operator M wants to touch. Then, if the body height of the operator M is shorter than the reference body height, a portion close to the tip of the finger touches the touch panel 131. Therefore, the actual touch position is deviated upwards from the position that the operator M wants to touch. Similarly, if the operation distance is different from the reference distance, a deviation occurs in the touch coordinates as in the case in which the angle of the touch panel 131 is different from the reference angle. Specifically, if the operation distance is longer than the reference distance, a portion close to the finger cushion touches the touch panel 131. Therefore, the actual touch position is deviated downwards from the position that the operator M wants to touch. If the operation distance is smaller than the reference distance, a portion close to the tip of the finger touches the touch panel 131. Therefore, the actual touch position is deviated upwards from the position that the operator M wants to touch.

The processor 111 may use known methods to derive the correction value x1 and the correction value y1. As an example, the processor 111 causes the touch panel to display an image for correction. The image for correction includes a mark for correction. The operator M touches the mark for correction. In response to this, the processor 111 derives the correction value x1 and the correction value y1 for correcting the deviation between the coordinates (x, y) touched by the operator M and the coordinates (x0, y0) indicating the mark for correction. For example, the processor 111 derives the correction value x1 and the correction value y1 according to x1=x0−x, y1=y0−y. The processor 111 may cause the operation panel 13 to display an image including a plurality of marks for correction to enable the operator M to sequentially touch a plurality of marks for correction. Alternatively, the processor 111 may cause the operation panel 13 to display the image for correction plural times to enable the operator M to touch the mark for correction plural times. Then, the processor 111 may derive the correction value x1 and the correction value y1 based on plural times of the touch by the operator M.

The processor 111 causes the auxiliary storage device 12 to store the reference angle, the reference body height and the reference distance together with the derived correction value x1 and correction value y1. The processor 111 overwrites the correction value x1, the correction value y1, the reference angle, the reference body height and the reference distance already stored in the auxiliary storage device 12 to store them in the auxiliary storage device 12. The reference angle is the angle of the operation panel 13 when the correction value x1 and the correction value y1 are derived. Therefore, the reference angle is an angle stored as the variable VA at the time of execution of the process in Act 15. The reference body height is the body height of the operator M when the correction value x1 and the correction value y1 are derived. Therefore, the reference body height is, for example, the body height measured in Act 5 at the latest. The reference distance is the operation distance when the correction value x1 and the correction value y1 are derived. Therefore, the reference distance is, for example, the operation distance measured in Act 4.

The processor 111 returns to the process in Act 7 after the process in Act 15.

If the operation for starting the login is performed in the standby state in Act 9 to Act 14, the processor 111 determines Yes in Act 10 and proceeds to the process in Act 16.

In Act 16, the processor 111 executes a process relating to the login. For example, the processor 111 stands by until a user ID and a password are input to the operation panel 13. The processor 111 causes, for example, the RAM 113 to store the user ID as an ID during login if the combination of the correct user ID and password is input. Alternatively, the processor 111 stands by until a card reader reads an IC (integrated circuit) card. The IC card stores the user ID and the like. The processor 111 causes, for example, the RAM 113 to store the user ID as the ID during login if a legitimate IC card is read. Alternatively, the processor 111 may stand by until biometric information of the operator M is input. If the biometric information is input, the processor 111 specifies the user ID from the biometric information and stores it as the ID during login. The ID during login is a user ID of the user who is logging in. By performing the login process as described above, the image forming apparatus 10 is switched to a login state.

In Act 17, the processor 111 reads the personal setting stored in the auxiliary storage device 12 in association with a login ID. The processor 111 causes the RAM 113 to store the read personal settings, for example. The processor 111 returns to the process in Act 7 after the process in Act 17.

If the operation for changing the angle of the operation panel 13 is performed when the processor 111 is in the standby state in Act 9 to Act 14, the processor 111 determines Yes in Act 11 and proceeds to the process in Act 18 in FIG. 5.

In Act 18, the processor 111 acquires the angle of the operation panel 13 from the angle sensor 135. Then, the processor 111 substitutes the acquired angle for the variable VA. The processor 111 returns to the process Act 7 after the process in Act 18.

If the operation for confirming and changing personal setting is performed in the standby state in Act 9 to Act 14, the processor 111 determines Yes in Act 12 and proceeds to the process in Act 19.

In Act 19, the processor 111 causes the touch panel 131 to display the correction value y2 and the correction value Y stored in Act 8 in FIG. 4.

The processor 111 also causes the operation panel 13 to display the contents of the personal setting stored in the RAM 113 on the touch panel 131. The habits of touching the touch panel 131 differ for different persons. The personal setting is a correction value which can be set for each user in order to correct for these habits.

In Act 20, the processor 111 stands by until an operation for instructing change of the personal setting is performed. If the operation for instructing the change of the personal setting is performed, the processor 111 determines Yes in Act 20 and proceeds to the process in Act 21.

In Act 21, the processor 111 causes the RAM 113 to store the contents of the personal setting based on the operation performed in Act 20. Furthermore, if the image forming apparatus 10 is in the login state, the processor 111 causes the auxiliary storage device 12 to store the content of the personal setting in association with the login ID. The processor 111 returns to the process in Act 7 after the process in Act 21.

As described above, the processor 111 proceeds to the process in Act 7 after the processes in Act 6, Act 15, Act 17, Act 18 or Act 21. The processor 111 then derives the correction value y2 and the correction value Y in Act 7. Here, the correction value y2 and the correction value Y are described.

The correction value y1, the correction value y2 and the correction value Y have, for example, the relationship Y=y1+y2. Different from the correction value y1, the correction value Y can correct the touch coordinates appropriately even if the angle of the operation panel 13 is not the reference angle, the body height of the operator M is not the reference body height, or the operation distance is not the reference distance.

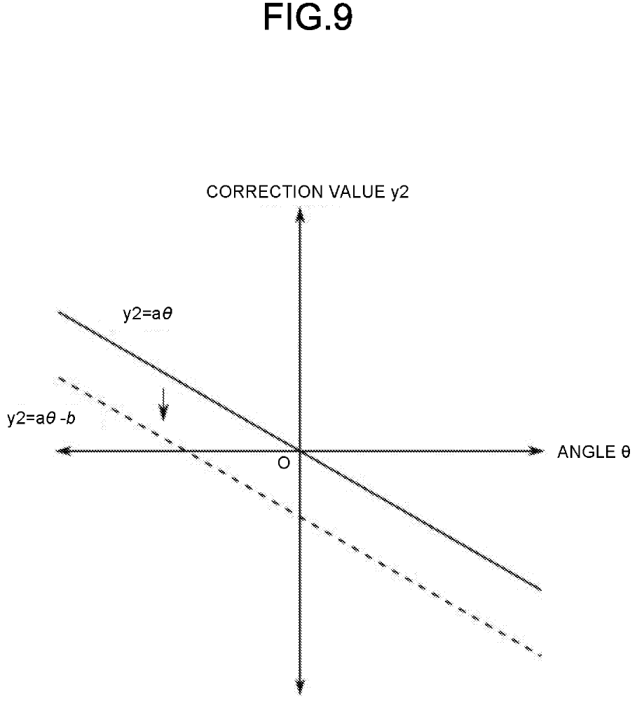

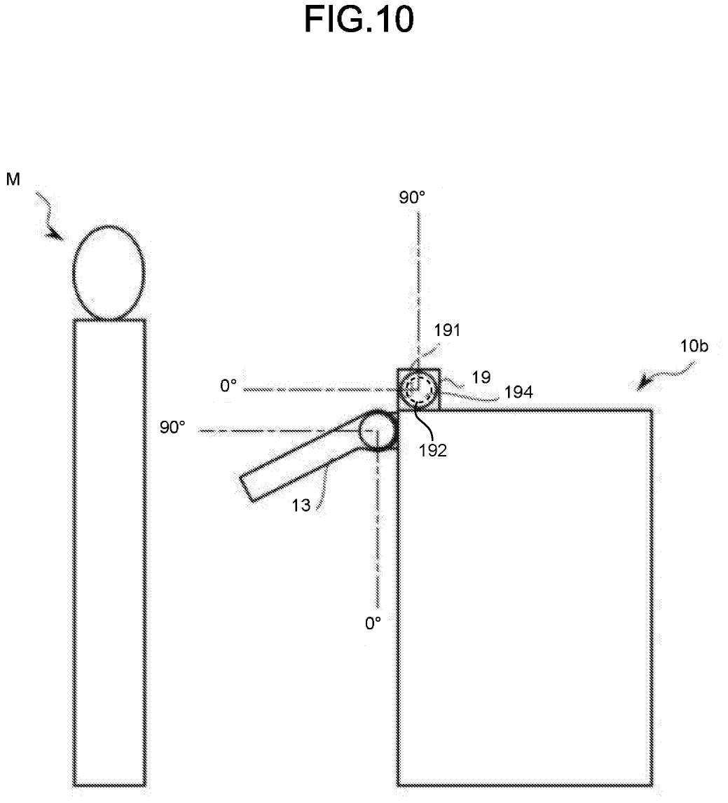

The correction value y2 is derived using an angular difference obtained by subtracting the angle of the operation panel 13 from the reference angle, as shown in FIG. 9. This angular difference is referred to as an angle θ. FIG. 9 is a diagram illustrating an example of the relationship between the angle θ obtained by subtracting the angle of the operation panel 13 from the reference angle and the correction value y2. In a case in which the body height of the operator M is the reference body height and the operation distance is the reference distance, y2 and θ have a relationship of y2=aθ as shown in FIG. 9 as an example. a is a real number. The value of a can be obtained by experiments, for example.

In addition, if the body height of the operator M is not the reference body height and if the operation distance is not the reference distance, y2 and θ have a relationship of y2=aθ−b as shown in FIG. 9 as an example. b is a real number. b becomes a larger value as the body height of the operator M is taller and as the operation distance is shorter. If the body height of the operator M is taller than the reference body height and the operation distance is the reference distance, b is a positive value. If the body height of the operator M is shorter than the reference body height and the operation distance is the reference distance, b is a negative value. If the body height of the operator M is the reference body height and the operation distance is smaller than the reference distance, b is a positive value. If the body height of the operator M is the reference body height and the operation distance is longer than the reference distance, b is a negative value. In the case in which the body height of the operator M is taller than the reference body height and the operation distance is longer than the reference distance, b may be a positive value or a negative value in some cases. If the body height of the operator M is smaller than the reference body height and the operation distance is smaller than the reference distance, b may be a positive value or a negative value. If (body height of the operator M−reference body height) is set to α and (reference distance−operation distance) is set to β, b is obtained by a function f(α, β) of α and β. In other words, b=f(α, β). The function f can be determined by experiments or the like.

The relationship between y2 and θ is not limited to a linear function but may be another function such as a quadratic function. y2 can be obtained by a function g(θ) of θ if the body height of the operator M is the reference body height and the operation distance is the reference distance. In other words, y2=g(θ). Then, if the body height of the operator M is not the reference body height and if the operation distance is not the reference distance, the relationship can be expressed as y2=g(θ)+f(α, β).

Alternatively, y2 may be determined by a function h(θ, α, β) of θ, α and β. In other words, y2=h(θ, α, β). The function h can be determined by experiments or the like.

If the personal setting is stored in the RAM 113, the processor 111 derives the correction value y2 by taking the personal setting into account. For example, the processor 111 changes the value of a to a larger value or a smaller value according to the personal setting. Alternatively, the processor 111 may change the value of b to a larger value or a smaller value depending on the personal setting, for example. The processor 111 may change the function f to a different function f′ according to the personal setting. The processor 111 may change the function g to a different function g′ according to the personal setting. The processor 111 may change the function h to a different function h′ according to the personal setting.

The processor 111 derives the correction value Y according to Y=y1+y2 after deriving the correction value y2 as described above.

If the touch operation is performed on the touch panel 131 while in the standby state in Act 9 to Act 14, the processor 111 determines Yes in Act 13 and proceeds to the process in Act 22.

In Act 22, the processor 111 acquires coordinates (x, y) at which the touch operation is performed from the touch panel 131.

In Act 23, the processor 111 applies the correction value x1 and the correction value Y to the coordinates acquired in Act 22. As a result, the processor 111 derives the corrected coordinates (x+x1, y+Y).

The processor 111 adds the correction value y2 to an input position coordinate y by performing the process in Act 23.

In Act 24, the processor 111 carries out a process in response to the touch on the coordinate by assuming that the corrected coordinates (x+x1, y+Y) are touched. The processor 111 returns to Act 9 in FIG. 4 after the process in Act 24.

If the operation by the operator M is finished in the standby state in Act 9 to Act 14, the processor 111 determines Yes in Act 14 and proceeds to the process in Act 25. For example, the processor 111 determines that the operation by the operator M is finished if a state in which there is no operation continues for a certain period of time. If various operations such as printing, scanning, copying or faxing are not performed, and a time during which no operation is performed on the operation panel 13 continues for a certain time or more, the processor 111 determines that it enters the state in which there is no operation. Alternatively, for example, if the state in which no operation is performed continues for a certain period of time, and no operator M is present within the detection range of the human sensor 132, the processor 111 may determine that the operation by the operator M is finished. The processor 111 controls the motor 133 to reduce the angle of the operation panel 13. At this time, the processor 111 acquires the output value of the human sensor 132. At a time point at which the output value becomes equal to or greater than the threshold value U1, the processor 111 determines that the operator M is present within the detection range of the human sensor 132. On the other hand, if the output value of the human sensor 132 is not equal to or greater than the threshold value U1 even in a case in which the angle of the operation panel 13 is lowered to a certain value, the processor 111 determines that there is no operator M within the detection range of the human sensor 132. The processor 111 controls the motor 133 to return the angle of the operation panel 13 to an original angle thereof after changing the angle of the operation panel 13 to determine whether or not the operator M is present. The processor 111 also determines that the operation by the operator M is finished if an operation instructing the termination of the operation is performed.

In Act 25, the processor 111 executes a logout process when it is in the login state. At this time, the processor 111 erases the ID during login stored in the RAM 113. Through the logout process, the image forming apparatus 10 shifts from the login state to the logout state. The processor 111 erases the personal setting, the correction value y2 and the correction value Y stored in the RAM 113. The processor 111 returns to the process in Act 2 after the process in Act 25.

The image forming apparatus 10 of the embodiment adds the correction value y1 and the correction value y2 to the coordinate y. The correction value y2 is used for correcting the coordinates appropriately even if the angle of the touch panel 131 is not the reference angle. Therefore, the image forming apparatus 10 of the embodiment can suppress the deviation of the input coordinates with respect to the touch panel 131 even if the angle of the touch panel 131 is changed after deriving the correction value y1 at the reference angle. Therefore, even if the angle of the touch panel 131 is changed after deriving the correction value y1 at the reference angle, the image forming apparatus 10 of the embodiment does not need to derive the correction value y1 again, which saves time for re-calculation.

Furthermore, the image forming apparatus 10 of the embodiment uses the body height of the operator M in the derivation of the correction value y2. Therefore, the image forming apparatus 10 of the embodiment can suppress the deviation of the input coordinates with respect to the touch panel 131 which is caused by the body height of the operator M.

The image forming apparatus 10 of the embodiment uses the distance between the operator M and the image forming apparatus 10 to derive the correction value y2. Therefore, the image forming apparatus 10 of the embodiment can suppress the deviation of input coordinates with respect to the touch panel 131 which is caused by the distance between the operator M and the image forming apparatus 10.

The image forming apparatus 10 measures the body height of the operator M using the human sensor 132. Therefore, the operator does not need to input the body height of the operator himself/herself.

The image forming apparatus 10 of the embodiment stores the personal setting in the auxiliary storage device 12 in association with the user ID. Therefore, the image forming apparatus 10 of the embodiment can derive the appropriate correction value y2 for each operator. Once the operator changes the personal setting, the personal setting is also applied in the next login, which saves time and labor.

The image forming apparatus 10 of the embodiment displays the correction value y2 and the correction value Y on the touch panel 131. Therefore, it is easy to understand how much the correction is made in the image forming apparatus 10 of the embodiment. The operator may use the displayed correction value y2 and the correction value Y as reference for changing the personal setting.

The above embodiment can also be modified as follows.

The human sensor may be provided independently of the operation panel 13 as shown in FIG. 10. FIG. 10 is a side view depicting a modification of the image forming apparatus. An image forming apparatus 10b shown in FIG. 10 includes a sensor unit 19. The sensor unit 19 includes a human sensor 191, a motor 192, and a rotating section 194. The motor 192 changes the orientation of the human sensor 191 in a rotation direction of the rotating section 194 by rotating the sensor unit 19 around the rotating section 194. As shown in FIG. 10, the sensor unit 19 is rotatable around a rotation center of the rotating section 194 within a range including 0 degree to 90 degrees as an example. The angle of the sensor unit 19 when the sensor direction of the human sensor 191 is parallel to the ground and the sensor direction faces the side where the operator M is present is set to 0 degree. The angle of the sensor unit 19 when the sensor direction of the human sensor 191 is perpendicular to the ground and the sensor direction is directed upwards is set to 90 degrees. In this way, since the human sensor 191 is rotatably provided independently of the operation panel 13, the image forming apparatus 10b can measure the body height without rotating the operation panel 13. The image forming apparatus 10b can measure the operation distance irrespective of the angle of the operation panel 13.

From the above, the processor 111 cooperates with the human sensor 191 to function as a second measurement section for measuring the body height of the operator.

In the above embodiment, the image forming apparatus 10 uses the body height of the operator M, the operation distance, the angle of the operation panel 13, the reference body height, the reference distance, and the reference angle to derive the correction value y2 and the correction value Y. However, the image forming apparatus 10 may derive the correction value y2 and the correction value Y without using the body height of the operator M and the reference body height. In this case, the image forming apparatus 10 derives the correction value y2 and the correction value Y on the assumption that the body height is constant regardless of the operator M, for example. In this case, the image forming apparatus 10 does not need to measure the body height. As described above, even if the body height of the operator M and the reference body height are not used to derive the correction value y2 and the correction value Y, the image forming apparatus 10 can reduce the deviation of coordinates when compared with a conventional image forming apparatus without using the correction value y2 and the correction value Y.

In addition, the image forming apparatus 10 may derive the correction value y2 and the correction value Y without using the operation distance and the reference distance. In this case, the image forming apparatus 10 derives, for example, the correction value y2 and the correction value Y as the operation distance is constant. In this case, the image forming apparatus 10 does not need to measure the operation distance. As described above, even if the operation distance and the reference distance are not used to derive the correction value y2 and the correction value Y, the image forming apparatus 10 can reduce the deviation of the coordinates when compared with the conventional image forming apparatus without using the correction value y2 and the correction value Y.

The correction value Y may vary depending on a position touched by the operator M in a y coordinate direction on the surface of the touch panel 131. A portion close to the finger cushion touches the touch panel 131 as the touched location is positioned on the upper side in a y coordinate direction on the surface of the touch panel 131. A portion close to the tip of the finger touches the touch panel 131 as the touched location is positioned on the lower side in a y coordinate direction on the surface of the touch panel 131. Therefore, the correction value y2 becomes larger as the touched location by the operator M is on the upper side in a y coordinate direction on the surface of the touch panel 131. In this case, the correction value y2 is a function of the coordinate y of the touched location. The function can be determined by experiments and the like.

The correction value y2 or the correction value Y may have upper limit values, respectively. For example, the image forming apparatus 10 uses the value of the correction value y2 or the correction value Y as an upper limit value when the derived correction value y2 or correction value Y exceeds the upper limit value thereof. By setting the upper limit value for the correction value y2 or the correction value Y, the image forming apparatus 10 can prevent the excessive correction.

The image forming apparatus 10 may measure the body height of the operator M and the operation distance again before executing the process in Act 15 after determining Yes in Act 9. Then, the image forming apparatus 10 derives the correction value x1 and the correction value y1 using the newly measured body height and operation distance. In this way, the image forming apparatus 10 can more accurately derive the correction value x1 and the correction value y1.

The image forming apparatus 10 may store the correction value x1 and the correction value y1 for each user. For example, if the correction value x1 and the correction value y1 are derived through the process in Act 15 while logging in, the image forming apparatus 10 stores the correction value x1 and the correction value y1 in association with the login ID. Then, in the login state, if there is the correction value x1 and the correction value y1 associated with the login ID, the image forming apparatus 10 uses the correction value y1 to calculate the correction value y2 and the correction value Y. The image forming apparatus 10 performs the process in Act 23 using the correction value x1.

The image forming apparatus 10 may continue to measure the operation distance repeatedly. The processor 111 may derive the correction value y2 and the correction value Y again according to the latest measured operation distance. As a result, even if the position where the operator M is present is changed many times, the image forming apparatus 10 can appropriately perform the correction.

In the above embodiment, the image forming apparatus 10 measures the body height of the operator M using the human sensor 132. However, the image forming apparatus 10 may measure the body height of the operator M by other methods. Instead of measuring the body height, the image forming apparatus 10 may ask the operator M to input his/her body height. In response to this, the operator M manually inputs his/her body height. If the body height is manually input in the login state, the image forming apparatus 10 may store the body height in the auxiliary storage device 12 in association with the user ID. Then, in the login state, if there is a body height stored in association with the login ID, the image forming apparatus 10 calculates the correction value y2 and the correction value Y using the body height. As a result, it is not necessary to input the body height again.

In the above embodiment, the body height and the operation distance are measured by one human sensor 132. However, the image forming apparatus 10 may separately have two sensors including a sensor for measuring the body height and a sensor for measuring the distance. As a result, the image forming apparatus 10 can perform the height measurement and distance measurement at the same time.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a housing;
an input unit comprising an input section, a sensor configured to detect an object within an area facing the input section and output a signal in response to detection of an object within the area facing the input section, and a rotary coupling having an axis of rotation and connecting the input unit to the housing, such that the input unit is positionable by the swinging thereof along a path centered on the axis of rotation to position the input section to face different directions;
a motor connected to the coupling; and
a controller configured to receive the signal from the sensor, and selectively control the motor to change the facing direction of the input section based on the value of the signal output by the sensor.

2. The image forming apparatus according to claim 1, wherein
the value of the signal output by the sensor is dependent upon the distance between the sensor and an object within the area facing the input section.

3. The image forming apparatus according to claim 1, wherein
the value of the signal output by the sensor is dependent on the presence or non-presence of an object within the area facing the input section.

4. The image forming apparatus according to claim 1, wherein
the controller is further configured to determine the height of an object within the area facing the input section based upon a change in the value of the signal output by the sensor.

5. The image forming apparatus according to claim 1, wherein
the controller is further configured to determine the distance from the sensor to an object within the area facing the input section based upon a change in the value of the signal output by the sensor.

6. The image forming apparatus according to claim 1, further comprising
a memory coupled to the controller, the memory storing preset positions of the input section on the path centered on the axis of rotation, the preset positions related to the distance of a detected object from the sensor.

7. The image forming apparatus according to claim 1, further comprising
a memory coupled to the controller, the memory storing preset positions of the input section on the path centered on the axis of rotation, the preset positions related to the height of a detected object.

8. The image forming apparatus according to claim 1, wherein
the object is a user of the image forming apparatus; and
the controller is further configured to adjust the position of the input section on the path centered on the first axis of rotation from the preset position related to the height of the object in response to at least one of a user input to the input section and the identity of the user.

9. An image forming apparatus, comprising:
a housing;
an input unit comprising an input section, and a first rotary coupling having a first axis of rotation and connecting the input unit to the housing, such that the input unit is positionable by the swinging thereof along a first path centered on the first axis of rotation;
a first motor connected to the first rotary coupling;
a sensor configured to detect an object within an area facing the sensor and output a signal in response to detection of an object within the area facing the sensor;
a second rotary coupling having a second axis of rotation connecting the sensor to the housing, such that the sensor is positionable by the movement thereof along a second path centered on the second axis of rotation to position the sensor to face different directions;
a second motor connected to the second rotary coupling; and
a controller configured to receive the signal from the sensor in response to detection of an object within the area facing the sensor, and selectively control the first motor to change the facing direction of the input section based on the value of the signal.

10. The image forming apparatus according to claim 9, wherein
the value of the signal output by the sensor is dependent upon the distance between the sensor and an object within the area facing the sensor.

11. The image forming apparatus according to claim 9, wherein
the value of the signal output by the sensor is dependent on the presence or non-presence of an object within the area facing the sensor.

12. The image forming apparatus according to claim 9, wherein
the controller is further configured to determine the height of an object within the area facing the sensor based upon a change in the value of the signal output by the sensor.

13. The image forming apparatus according to claim 9, wherein
the controller is further configured to determine the distance from the sensor to an object within the area facing the sensor based upon a change in the value of the signal output by the sensor.

14. The image forming apparatus according to claim 9, further comprising
a memory coupled to the controller, the memory storing preset positions of the input section on the path centered on the first axis of rotation, the preset positions related to the distance of a detected object from the sensor.

15. The image forming apparatus according to claim 9, further comprising
a memory coupled to the controller, the memory storing preset positions of the input section on the path centered on the first axis of rotation, the preset positions related to the height of a detected object.

16. The image forming apparatus according to claim 9, wherein
the object is a user of the image forming apparatus; and
the controller is further configured to adjust the position of the input section on the path centered on the first axis of rotation from the preset position related to the height of the object in response to at least one of a user input to the input section and the identity of the user.

17. A method for adjusting a direction of an input unit in an image forming apparatus having a housing, the input unit comprising an input section, a sensor configured to detect an object within an area facing the input section and output a signal, and a rotary coupling having an axis of rotation and connecting the input unit to the housing, such that the input unit is positionable by the swinging thereof along a path centered on the axis of rotation to position the input section to face different directions, and a motor connected to the coupling, the method comprising:
receiving a signal from the sensor; and
selectively controlling the motor to change the facing direction of the input section based on the value of the signal.

18. The method according to claim 17, wherein
the value of the signal output by the sensor is dependent upon the distance between the sensor and an object within the area facing the input section.

19. The method according to claim 17, wherein
the value of the signal output by the sensor is dependent on the presence of the object within the area facing the input section.

20. The method according to claim 17, further comprising:
determining the height of an object within the area facing the input section based upon a change in the value of the signal output by the sensor.
